(19) United States
(12) Patent Application Publication
(10) Pub. No.: US 2026/0327074 A1
(43) Pub. Date: Oct. 22, 2026

(54) METHOD FOR PRODUCING ALKALI SULFONYL IMIDE SALTS

(71) Applicant: SPECIALTY OPERATIONS FRANCE, Lyon (FR)

(72) Inventors: Elie Derrien, Brignais (FR); Etienne Schmitt, Soucieu-En-Jarrest (FR); Vincent Schanen, Lyon (FR)

(73) Assignee: SPECIALTY OPERATIONS FRANCE, Lyon (FR)

(21) Appl. No.: 19/113,883

(22) PCT Filed: Sep. 20, 2023
(86) PCT No.: PCT/EP2023/075914

§ 371 Date: Mar. 20, 2025

(30) Foreign Application Priority Data
Sep. 22, 2022 (EP) 22306391.8

(51) Int. Cl. C01B 21/084; H01M 10/0568

(52) U.S. Cl. CPC C01B 21/084; H01M 10/0568; H01M 2300/0025

(57) ABSTRACT

The present invention relates to a method for producing a salt of bis(chlorosulfonyl)imide (HCSI salt), which is economically feasible at industrial scale and which provides a high-purity product. The present invention also provides a method for producing a lithium salt of bis(fluorosulfonyl)imide (LiFSI), wherein said HCSI salt is used as an intermediate compound.

### CROSS REFERENCE TO RELATED PATENT APPLICATIONS

This application claims priority filed on 22 Sep. 2022 in Europe with Nr 22306391.8, the whole content of this application being incorporated herein by reference for all purposes.

### TECHNICAL FIELD

The present invention relates to a method for producing a salt of bis(chloro sulfonyl)imide, which is economically feasible at industrial scale and which provides a high-purity product. The present invention also provides a method for producing a lithium salt of bis(fluoro sulfonyl)imide (LiFSI), wherein said HCSI salt is used as an intermediate compound.

### BACKGROUND

Fluorosulfonyl Imide salts, in particular the lithium salt of bis(fluorosulfonyl)imide (LiFSI), are useful compounds for battery electrolytes. Different processes, reactants and intermediates leading to LiFSI have been described in the patent literature. Patent CA 2 527 802 (in the name of Université de Montréal) lists several routes to prepare LiFSI, for example the process for preparing LiFSI in one step starting from bis(chlorosulfonyl)imide (HCSI) using anhydrous hydrogen fluoride (HF):

$${( {CISO}_{2} )}_{2} NH + LiF {anhydrous HF}_{\to } {( F {SO}_{2} )}_{2} NLi + \text{?}$$

Also, KR 20190001092 (in the name of LIM KWANG MIN) discloses a method for manufacturing lithium bis(fluorosulfonyl)imide (LiFSI) comprising reacting a lithiation agent, a solvent and bis(chlorosulfonyl)imide (HCSI) and a fluorination reagent.

Alternative known processes to prepare LiFSI encompass two-step processes. For example, one alternative is the fluorination of bis(chlorosulfonyl)imide (HCSI) into bis(fluorosulfonyl)imide (HFSI) using a fluorination agent, for example anhydrous hydrogen fluoride (HF), and then the lithiation of HFSI into LiFSI using a lithiation agent.

Another known two-step process for preparing LiFSI involves a first step of fluorination of bis(chlorosulfonyl)imide (HCSI) into ammonium bis(fluorosulfonyl)imide (NH₄FSI) using NH₄F(HF)ₓ as a fluorinating agent, followed by a second step of lithiation of NH₄FSI, leading then to the LiFSI product.

Another known two-step process for preparing LiFSI involves the lithiation of HCSI in a first step using a lithiation agent in order to prepare LiCSI as an intermediate product, and then the fluorination of LiCSI into LiFSI using a fluorination agent.

For example, KR 20200049164 (in the name of CLS LABORATORIES INC.) discloses a LIFSI preparation method, comprising the reaction of HCSI with a lithiation reagent in an (S1) solvent to produce LiCSI as an intermediate product, which is not purified/separated but is rather directly reacted with an anhydrous fluorination reagent without purification. After lithium bis(fluorosulfonyl)imide is obtained, it is then filtered and concentrated, and then the solvent is completely removed using a thin film distiller at low temperature, thus obtaining a crystalline powder. In this method, the reaction is performed using a single solvent and no additional crystallisation or re-crystallization process is performed.

Also, CN 103524387 (in the name of China Nat Offshore oil Corp.) discloses a preparation method for LiFSI comprising: (I) reacting sulfamic acid and chlorosulfonic acid in thionyl chloride solvent to prepare HCSI, (II) adding LiCl and remove the thionyl chloride solvent to obtain LiCSI, (III) add acetonitrile or butyl acetate and then add ZnF and filter to obtain a filtrate containing LiFSI salt, (IV) re-crystallize in methylene chloride to obtain a solid and drying.

Other processes for lithiation of HCSI have been disclosed for example in WO 02/053494 (in the name of Hydro-Quebec, Rhodia Chimie).

### SUMMARY OF THE INVENTION

The Applicant perceived that there is still the need in the art for improving the method for manufacturing the intermediate compounds that are used in the manufacture of LiFSI.

More in particular, the Applicant faced the technical problem of providing a method for manufacturing LiCSI having a low content of impurities such that it can be used for manufacturing LiFSI.

Also, the Applicant faced the problem of providing a method characterised by high productivity, using conditions suitable for the manufacture at industrial scale.

### DETAILED DESCRIPTION

In the present application:
the numerical ranges disclosed herein after should be understood as including the limits, unless otherwise specified;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list.

In a first aspect, the present application relates to a method for the manufacture of a salt of bis(chloro sulfonyl)imide [CSI salt] in solid form, said method comprising: (I) contacting at least one first solvent [solvent (S1)] and a compound complying with formula (1):

MₓB (1)
wherein
M is selected from lithium, sodium, potassium and ammonium;
x is 1 or 2; and
B is selected from Cl, CO₃²⁻, SO₄²⁻, carboxylate; silicate, preferably metasilicate; borate, preferably tetraborate; and mixtures thereof; to provide a first mixture [mixture (M1)];
(II) contacting said mixture (M1) with bis(chloro sulfonyl)imide (HCSI), so as to provide a second mixture [mixture (M2)] comprising a salt of HCSI [CSI salt]selected from lithium-, sodium-, potassium- or ammonium-CSI and at least one first solvent (S1);
(III) contacting said mixture (M2) with at least one second solvent [solvent (S2)], so as to provide the CSI salt in solid form,
wherein said at least one second solvent (S2) forms an homogeneous mixture with said at least one first solvent (S1), and is an anti-solvent for said CSI salt.

As used within the present description and in the following claims, the expression “anti-solvent for the CSI salt” referred to the at least one second solvent (S2) is intended to indicate that the CSI salt shows a solubility below 2 wt. %, preferably below 1 wt. % into said at least one second solvent (S2).

The method of the present invention can be performed continuously or batch wise.

For example, the method of the present invention can be stopped after step (II), to recover the CSI salt from mixture (M2).

According to this embodiment, the method of the present invention preferably comprises after step (II), a step (II-b) of isolating the CSI salt from mixture (M2).

Preferably, when in formula (1) M is lithium, said compound is selected from those that do not generate water or soluble species over the course of the reaction.

Advantageously, when in formula (1) M is lithium, said compound is selected from the group comprising: lithium chloride (LiCl), lithium carbonate (Li₂CO₃), lithium sulphate (Li₂SO₄), lithium carboxylate (Liₙ(RCO₂)ₙ), Li₂SiO₃, Li₂B₄O₇ and mixture thereof.

Preferably, in formula (1), M is sodium. Said compound is preferably selected in the group comprising: sodium chloride (NaCl), sodium carbonate (Na₂CO₃), sodium sulphate (Na₂SO₄), and mixture thereof.

Preferably, in formula (1), M is ammonium. Said compound is preferably selected in the group comprising ammonium chloride (NH₄Cl), ammonium carbonate, and mixture thereof.

Preferably, the molar ratio HCSI to the compound of formula (1) when M is lithium ranges from 1:100 to 20:1, in particular from 1:10 to 10:1, more particularly from 1:2 to 5:1, even more particularly from 1:1 to 1:1.5.

When lithium carbonate is used as the compound of formula (1), it is advantageous that the molar ratio of HCSI to Li₂CO₃ is lower than 1, i.e. that Li₂CO₃ is in excess. A molar ratio from 1:2 to 1:5 is even more preferred.

More preferably, said compound of formula (1) is anhydrous lithium chloride (LiCl) in a solid form.

When LiCl is used as the compound of formula (1) it is advantageous that the molar ratio of HCSI to LiCl is from 1:1 to 1:1.5.

Preferably, said solvent (S1) is selected in the group comprising: carbonates, such as dimethyl carbonate (DMC), diethyl carbonate (DEC), ethyl methyl carbonate (EMC) ethylene carbonate (EC), propylene carbonate (PC); esters, such as ethyl acetate, n-butyl-acetate; ethers, such as tetrahydrofuran (THF), methyl tert-butyl ether (MTBE), methyl tetrahydrofuran (Me-THF). Carbonates are particularly preferred.

In any case, solvent (S1) is different from thionyl chloride (SO₂Cl).

The HCSI provided in step (II) of the method of the present invention can be produced by a known method, for example by reacting:
chlorosulfonyl isocyanate (ClSO₂NCO) with chlorosulfonic acid (ClSO₂OH);
cyanogen chloride (CNCl) with sulfuric anhydride (SO₃), and with chlorosulfonic acid (ClSO₂OH); or
sulfamic acid (NH₂SO₂OH) with thionyl chloride (SOCl₂) and with chlorosulfonic acid (ClSOOH).

In one embodiment, the HCSI is produced by reacting chlorosulfuric acid (ClSO₂OH) and chlorosulfonyl isocyanate (ClSO₂NCO). According to this embodiment, step (i) consists in preparing a reaction mixture comprising a crude HCSI, heavy fractions and light fractions in a reactor, by reacting chlorosulfonyl isocyanate (ClSO₂NCO) with chlorosulfonic acid (ClSO₂OH).

In another embodiment, the HCSI is produced by reacting sulfamic acid (NH₂SO₂OH), chlorosulfonic acid (ClSO₂OH) and thionyl chloride (SOCl₂). The sulfamic acid to be applied may be ground to a certain particle size and dried under vacuum to decrease its water content and accelerate the kinetics of the transformation, which significantly reduces the reaction time. When HCSI is prepared by the so-called sulfamic route, the sulfamic acid employed can be optionally grinded and dried under vacuum, in order to decrease its water content and accelerate the kinetics of the transformation, hence reducing the reaction time significantly.

In the other embodiment, the HCSI is produced by reacting cyanogen chloride CNCl with sulfuric anhydride (SO₃) and chlorosulfonic acid (ClSO₂OH).

The HCSI can be provided as a composition comprising HCSI in admixture with at least one other compound. Such at least one other compound can be an undesired compound. Said undesired compound can be selected for example from ions, solvent(s), water and/or reaction by-products. For example, the HCSI may be provided in a composition comprising from 80 to 99 wt. % of HCSI, preferably 85-98 wt. %, more preferably 90-97 wt. %, the remaining up to 100 wt. % being one or more other compound(s). Such other compound(s) will be removed through the method of the present invention.

Advantageously, the HCSI is provided in step (II) in its molten form.

According to this embodiment, before step (II) HCSI is heated at a temperature above its melting temperature (Tm_{HCSI}).

Although the melting temperature of of HCSI is influenced by the presence and amounts of impurities, it is preferred that the HCSI is heated at a temperature equal to or higher than 30 °C, for example equal to or higher than 37 °C, for example equal to or higher than 38 °C, equal to or higher than 40 °C, equal to or higher than 45 °C or even equal to or higher than 50 °C. In any case, the heating is performed at a temperature that is below the degradation temperature of HCSI.

Preferably, step (II) is performed at a temperature from 15 to 60 °C, more preferably from 20 to 35 °C.

Preferably, step (II) is performed at atmospheric pressure.

Preferably, said at least one second solvent (S2) is selected in the group comprising: dioxane, chlorinated solvents such as dichloromethane (DCM), alkanes, toluene, xylenes. Dioxane is particularly preferred.

Preferably, step (III) is performed at a temperature from 15 to 60 °C, more preferably from 20 to 35 °C.

Preferably, step (III) is performed at atmospheric pressure.

Preferably, the CSI salt in solid form obtained at the end of step (III) is in the form of a solvate with said at least one second solvent (S2).

Preferably, the method according to the present invention comprises after step (III), at least one step (IV) of separating the CSI salt from impurities.

This separation step may be performed by any separation means known by the person skilled in the art. For example, the separation can be performed by filtration, more preferably under pressure and/or under vacuum, or decantation.

The mesh size of the filtration medium is preferably 100 μm or below, 50 μm or below, 10 μm or below, 2 μm or below, of 0.45 μm or below, or 0.22 μm or below.

The separated product(s) may be washed once or several times with appropriate solvent(s).

The separation step can be carried out one time or may be repeated twice or more.

Some of the steps or all steps of the method according to the invention are advantageously carried out in equipment capable of withstanding the corrosion of the reaction medium.

For this purpose, materials are selected for the part in contact with the reaction medium that are corrosion-resistant, such as the alloys based on molybdenum, chromium, cobalt, iron, copper, manganese, titanium, zirconium, aluminium, carbon and tungsten, sold under the Hastelloy® brands or the alloys of nickel, chromium, iron and manganese to which copper and/or molybdenum are added, sold under the name Inconel® or Monel™, and more particularly the Hastelloy C276 or Inconel 600, 625 or 718 alloys. Stainless steels may also be selected, such as austenitic steels and more particularly the 304, 304L, 316 or 316L stainless steels. A steel having a nickel content of at most 22 wt. %, preferably of between 6 wt. % and 20 wt. % and more preferentially of between 8 wt. % and 14 wt. %, is used. The 304 and 304L steels have a nickel content that varies between 8 wt. % and 12 wt. %, and the 316 and 316L steels have a nickel content that varies between 10 wt. % and 14 wt. %.

More particularly, 316L steels are chosen. Use may also be made of equipment consisting of or coated with a polymeric compound resistant to the corrosion of the reaction medium. Mention may in particular be made of materials such as PTFE (polytetrafluoroethylene or Teflon) or PFA (perfluoroalkyl resins). Glass equipment, such as glass-coated alloys, may also be used. It will not be outside the scope of the invention to use an equivalent material. As other materials capable of being suitable for contact with the reaction medium, mention may also be made of graphite derivatives. Materials for filtration have to be compatible with the medium used.

Fluorinated polymers (PTFE, PFA), loaded fluorinated polymers (Viton™), as well as polyesters (PET), polyurethanes, polypropylene, polyethylene, cotton, and other compatible materials can be used.

All raw materials used in the method according to the invention, including reactants, may preferably show very high purity criteria. Preferably, their content of metal components such as Na, K, Ca, Mg, Fe, Cu, Cr, Ni, Zn, is below 10 ppm, more preferably below 5 ppm, or below 2 ppm.

According to the method of the present invention, a pure or substantially pure salt of LiCSI is obtained as a solid. This means that the LiCSI salt may be used as such for other reactions, notably the preparation of LiFSI.

In another aspect, the present invention relates to a solid solvate complex [CSI solvate] comprising a solid lithium, sodium, potassium or ammonium salt of bis(chloro sulfonyl)imide and dioxane as the solvating solvent.

As used within the present description and in the following claims, the term “solvate” is intended to indicate the solid lithium, sodium, potassium or ammonium salt of bis(chloro sulfonyl)imide, also referred to as CSI salt, which comprises molecules of said solvent (S2) attached to it via non-covalent bonds.

Preferably, the weight ratio of CSI salt to solvent (S2), in the CSI solvate, is in the range from 1:1 to 1:4, as measured on the dry powder.

Advantageously, said solvent (S2) in said CSI solvate is dioxane.

Advantageously, said CSI solvate is obtained at the end of step (III) or step (IV) of the method according to the present invention.

Preferably, said CSI solvate is in the crystallised form.

In a further embodiment, the present invention relates to the use of the CSI solvate as obtained at the end of step (II) or step (IV) as defined above, for the manufacture of a salt of bis(fluorosulfonyl imide) [FSI salt].

Preferably, the FSI salt is selected from: lithium, ammonium and sodium salt.

A further object of the present invention relates to a method for the manufacture of a salt of bis(fluoro sulfonyl) imide [FSI salt], said method comprising: (V) contacting the CSI salt or the CSI solvate as above defined with at least one fluorinating agent, so as to obtain the FSI salt.

The fluorinating agent used in the method of the present invention is not limited.

Preferably, it is anhydrous hydrogen fluoride (aHF). Such aHF has advantageously a high purity, for example above 99.95 mol. %, with less than 1000 ppm of H₂O, less than 10 ppm of SO₂, less than 100 ppm of H₂SO₄, less than 20 ppm of H₂SiF₆ and less than 25 ppm of As.

When aHF is used as a fluorinating agent in step (V), it may be introduced in any form in the reaction mixture. It may be introduced as a liquid or it can be introduced as a gas in the reaction vessel. For example, step (V) can be performed by fluorinating the LiCSI using aHF gas in a fluidized bed.

According to other embodiments, the fluorinating agent is selected from the group comprising, preferably consisting of:
(i) KF(HF)ₚ wherein p is 0 or 1;
(ii) NaF(HF)ₚ wherein p is 0 or 1;
(iii) X₂F(HF)ₚ wherein X₂ is an onium cation, and p is 0 or 1;
(iv) NH₄F(HF)ₚ wherein p varies between 0 and 10;
(v) LiF;
(vi) ZnF₂.

According to a preferred embodiment, specific examples of the fluorinating agent (iv) include NH₄F, NH₄F·HF, NH₄F·2HF, NH₄F·3HF, and NH₄F·4HF.

The preferred fluorinating agent is (iv) NH₄F.

In the present invention, the fluorinating agent used in step (V) is preferably anhydrous. Moisture content may be preferably below 100 ppm, below 50 ppm or even below 10 ppm. The skilled person can determine the most suitable method to determine such moisture content. For example, such methods can include infrared techniques or Karl Fischer titration where applicable.

In some embodiments, the stoichiometry amount (also called molar amount) of fluorinating agent to the CSI salt in solid form is from 0.1:1 to 50:1, for example from 1:1 to 10:1, or from 2:1 to 8:1.

In some embodiments, the stoichiometry amount of fluorinating agent is not less than 2 equivalent per 1 mol of the CSI salt, preferably LiCSI, for example between 2 to 100 equivalents per 1 mol of CSI salt, preferably LiCSI. Preferably, the stoichiometry amount of fluorinating agent is between 2 to 80 equivalents per 1 mol of CSI salt, preferably LiCSI, or between 2 to 60 equivalents per 1 mol of CSI salt, preferably LiCSI. More preferably, the stoichiometry amount of fluorinating agent is between 2 to 50 equivalents per 1 mol of CSI salt, preferably LiCSI.

Preferably, step (V) is performed in the presence of a solvent.

Advantageously, when the CSI salt in solid form is the solvate with dioxane, said solvent is preferably dioxane.

Preferably, step (V) is performed at a temperature from 25 to 90 °C, more preferably from 40 to 90 °C.

Preferably, step (V) is performed at a pressure from 1 to 2 bar.

The residual HF present in the final reaction crude may be eliminated using any relevant method such as vaporisation under vacuum or stripping using an inert gas or the combination thereof.

The LiFSI as obtained with the method of the present invention advantageously shows at least one or even more preferably all the following:
a purity of at least 98 wt. %, for example between 99 wt. % and 100 wt. % or between 99.50 and 100%, as determined by ¹⁹F NMR;
a solvent content of less than 20 wt. %, less than 10 wt. %, less than 1 wt. %, preferably between 0 wt. % and 1 wt. %, as determined by GC;
a moisture content of less than 500 ppm, less than 100 ppm, less than 50 ppm or even less than 20 ppm, as determined by infrared methods.

The LiFSI of the present invention advantageously shows at least one of the following features, and preferably all the following:
a chloride (Cl⁻) content of below 100 ppm, preferably below 50 ppm, more preferably below 10 ppm, or more preferably below 2 ppm;
a fluoride (F⁻) content of below 100 ppm, preferably below 50 ppm, more preferably below 40 ppm, more preferably below 30 ppm, more preferably below 20 ppm; and
a sulfate (SO₄²⁻) content of below 100 ppm, preferably below 50 ppm, more preferably below 10 ppm, or more preferably below 2 ppm.

Fluoride and chloride contents may be measured by means of titration by argentometry using ion selective electrodes (or ISE). Sulfate content may be measured by ionic chrof the following features, and preferably all the following:
a purity of at leamatography or by turbidimetry.

Advantageously, the lithium bis(fluorosulfonyl)imide (LiFSI) prepared according to the method of the present invention can be used in an electrolyte composition for an electrochemical cell.

In a further aspect, the present invention to an electrolyte composition comprising the LiFSI as obtained with the method of the present invention. Advantageously, said electrolyte composition is a non-aqueous electrolyte composition.

Should the disclosure of any patents, patent applications, and publications which are incorporated herein by reference conflict with the description of the present application to the extent that it may render a term unclear, the present description shall take precedence.

The present invention will be illustrated by means of the following examples, which are illustrative of the present invention and not limiting.

### EXPERIMENTAL SECTION

### Materials

The following were purchased by Merck: anhydrous lithium chloride (99%-#793620); carbon tetrachloride (CCl₄→99.9%-#270652); dimethyl carbonate<diethyl carbonate (DEC-99%-#D91551).

The following were purchased by VWR: dichloromethane (DCM-#25631.293); dioxane (VWR #23532.297→99%).

HCSI was prepared internally starting from chlorosulfonyl isocyanate and chlorosulfonic acid, and then used in its molten state.

### Methods

All solvents used in the examples (DCM, CCl₄, DEC, DMC, dioxane) below were dried using molecular sieves before use.

### Comparative Example A1—Preparation of LiCSI Solution Via Lithiation of HCSI Using CCl₄ as the Solvent

A double-jacketed 100 mL glass reactor equipped with integrated baffles, a mechanical stirring, a condenser and connected to a 15 wt. % aqueous KOH scrubber was flushed with argon for 30 minutes. The reactor vessel was loaded with 3.18 g anhydrous lithium chloride and 24.7 g carbon tetrachloride.

In a glove box, a dropping funnel was filled with 26 g of CCl₄ and 20.0 g molten HCSI. The funnel was connected to the reactor.

The temperature setpoint of the condenser was fixed at 6 °C and the stirring rate at 700 rpm before introducing the HCSI solution over 20 min. The reaction medium was heated to reflux. After 5 hours of reflux, LiCl conversion was about 19% (estimated by KCl titration in the scrubber).

The reflux was prolonged for 60 hours with CCl₄ makeup to correct solvent losses.

The slurry was filtered, washed with 20 mL of CCl₄ and dried under argon to obtain a slight brown powder (8.3 g).

The proton NMR of the filtrate diluted in CDCl₃ showed the presence of HCSI and the titration of chlorides in the solid suggests 6 wt. % of remaining LiCl in LiCSI.

Overall, the reaction rate was considered too slow.

### Example A2—Preparation of LiCSI Solution Via Lithiation of HCSI Using DEC as the Solvent

A double-jacketed 250 mL glass reactor equipped with integrated baffles, a mechanical stirring, a condenser, a bottom valve and connected to a 15 wt. % aqueous KOH scrubber was flushed with nitrogen for 60 minutes. The reactor vessel was loaded with 6.34 g anhydrous lithium chloride and 15.98 g diethyl carbonate (DEC).

In a glove box, a glass flask was filled with 31.77 g of molten HCSI and 15.98 g DEC. The slight yellow solution formed was transferred to a syringe and mounted on a syringe pump.

The temperature setpoint of the condenser was fixed at 10 °C, the reaction mixture at 25 °C and the stirring rate at 400 rpm before introducing 47.84 g of the HCSI solution over 27 min.

The stirring and temperature were maintained for 7.6 hours. A beige slurry was obtained which easily settled.

The HCSI conversion estimated by HCl evolution was 97.0%.

The supernatant was analysed by NMR: no HCSI was detected by proton NMR and LiCSI signal was visible by ⁷Li NMR at 1.08 ppm.

The reaction crude was diluted with 18.99 g DEC and withdrawn to a filter under controlled N₂ atmosphere. The solid residue containing the excess LiCl was washed with 2.00 g DEC and 79.25 g filtrate was recovered containing 36 wt. % LiCSI.

Overall, very high selectivity was achieved and the full conversion required only a few hours using mild conditions.

### Example A3—Preparation of LiCSI Solution Via Lithiation of HCSI Using DEC as the Solvent

A double-jacketed 500 mL glass reactor equipped with integrated baffles, a mechanical stirring, a condenser, a bottom valve and connected to a 15 wt. % aqueous KOH scrubber was flushed with nitrogen for 60 minutes. The reactor vessel was loaded with 56.5 g anhydrous lithium chloride and 94.3 g DEC.

In a glovebox, a dropping funnel was filled with 192.9 g molten HCSI (prepared from chlorosulfonyl isocyanate and chlorosulfonic acid) and 100.8 g DEC. The funnel was then connected to the reactor.

The temperature setpoint of the condenser is fixed at 13 °C, the reaction mixture at 30 °C and the stirring rate at 400 rpm before introducing the HCSI solution over 45 min. The stirring and temperature were maintained for 4.5 hours.

The HCSI conversion estimated by HCl evolution was 98.6%.

The reaction crude was withdrawn and filtered inside a glovebox, 354 g transparent filtrates were isolated along with 18 g of solid residue.

The filtrate was analysed by NMR: no HCSI was detected by proton NMR and LiCSI signal was observed at 1.14 ppm in ⁷Li-NMR.

### Comparative Example B1—Preparation of Solid LiCSI Using DCM as Antisolvent

32.9 g of LiCSI solution obtained as described in Example A2 above were concentrated using a rotavapor at 50 °C and 8 mbar under nitrogen atmosphere to 20.0 g.

36.5 g of dichloromethane (DCM) were added to the concentrate LiCSI at room temperature and the mixture was stored at −26 °C for 16 hours. A white solid was formed, the suspension was filtered on a 0.22 micron PTFE membrane in a glovebox.

A solid cake was observed, which was washed 3 times with 10 g DCM and dried to provide a thin white powder.

The powder was analysed by NMR (¹H, ⁷Li) and FTIR. LiCSI was observed and its recovery rate was poor, i.e. 14% (1.8 g).

### Comparative Example B2—Crystallisation of LiCSI from DEC Solution

20.35 g of LiCSI solution obtained as described in Example A2 above were loaded in a 25 mL three-necked glass round bottom flask equipped with a PTFE stirring rod in a glovebox under argon atmosphere.

The flask was connected to a vacuum pump and dived into a thermostatic bath, then DEC evaporation was performed at 8 mbar, 35 °C and 600 rpm. After 2 hours, DEC was no longer evaporating and the LiCSI concentration had reached 54 wt. %.

The concentrated solution was seeded with 13 mg solid LiCSI and stored at −26 °C. After 7 days, no significant LiCSI crystallisation was visible.

### Example B3—Preparation of Solid LiCSI Using Dioxane as Antisolvent

36.1 g of LiCSI solution obtained as described in Example A3 above were mixed with 100 g dioxane in a glovebox. The solution was seeded with 53 mg solid LiCSI obtained following the procedure described in Example A3 and stored at −26 °C for 3 days. The sample coming back to room temperature was a white suspension, which was filtered on 0.22 micron PTFE membrane and washed with dioxane.

The cake was dried under vacuum at 50 °C to obtain a dry white powder (25.87 g) still containing 47 wt % dioxane (as determined by ¹H NMR and DSC analysis).

The LiCSI recovery yield was 75%.

### Example C1—Preparation of LiFSI Starting from LiCSI·Dioxane Solvate in Dioxane with aHF

In a preliminary thoroughly inerted C276 autoclave equipped with a magnetically coupled stirrer, a heating/cooling double-jacket, a temperature probe, a pressure sensor, a condenser and connected to a basic aqueous scrubber, was introduced under N₂ blanketing solid LiCSI·Dioxane (23 g, Dioxane content 47 wt. %) prepared following the procedure in Example B3.

Dioxane (91.4 g) was charged subsequently by cannulation. After 15 min of homogenization by stirring at 800 rpm, anhydrous HF (66 g) was introduced progressively. After complete addition of HF, the resulting mixture was heated at 70 °C for 22 h. Pressure reached a maximum of 1.6 bar.

After pressure release, the reaction mixture was stripped with N2 for 12 h at 50 °C to evacuate most of HF excess.

Quantitative ¹⁹F NMR of the reaction mixture showed LiFSI as the main species with a selectivity higher than 72%. Chlorides titration of the scrubber showed a high conversion ~96%.

### Comparative Example C2—Preparation of LiFSI Starting from LiCSI Solution in DEC with aHF

A solution of LiCSI 50.4% wt in DEC (111.6 g) was charged into the vessel disclosed in Example C1 by cannulation under N₂ blanketing. After 15 minutes of homogenization by stirring at 800 rpm, anhydrous HF (8.5 g) was introduced progressively. The mixture was heated at 70 °C for 43 hours. The reaction mixture was stripped with N₂ for 12 hours at 50 °C to evacuate most of HF excess. Fluorides/Chlorides titration of the scrubber showed a low conversion (25.1% chloride recovery in the scrubber).

Quantitative ¹⁹F-NMR of the reaction mixture showed a mixture of LiFSI (7.2%) with important amounts of FSO₃Li, FSO₂NH₂ (or its lithium salt), residual HF and other unknown impurities.

### Comparative Example C3—Preparation of LiFSI Starting from LiCSI Solution in DEC with NH₄F

A 50 mL glass round-bottom flask equipped with a condenser, a magnetic stirring, a thermostated oil bath is flushed with nitrogen for 30 min. The reactor vessel was loaded with 15.55 g diethyl carbonate and 7.74 g NH₄F.

In a glovebox, a 60 mL PP syringe was filled with 48 g LiCSI solution obtained by HCSI lithiation in DEC (37 wt. % LiCSI) and mounted on a syringe pump. The temperature setpoint of the condenser was fixed at 10 °C, the reaction mixture at 60 °C and the stirring rate at 400 rpm before introducing 46.34 g of the LiCSI solution over 60 min. The medium temperature was then set at 75-80 °C for 10 hours. After cooling down to room temperature, the supernatant was sampled: the total chloride content was around 60% of its initial value (titration in aqueous solution) showing that LiCSI was not fully converted. The ¹⁹F-NMR showed the formation of FSI anion at 53.0 ppm along with side products (FSI yield=30%).

Heating at 75-85 °C was prolonged for 5 hours, then supernatant was sampled again: chloride content has lowered to 50 ppm, FSI yield from ¹⁹F-NMR analysis was 53%. However, no lithium signal could be detected in the liquid phase by ⁷Li-NMR.

1. A method for the manufacture of a salt of bis(chloro sulfonyl)imide [CSI salt] in solid form, said method comprising:
(I) contacting at least one first solvent [solvent (S1)] and a compound complying with formula (1):
MₓB (1)
wherein
M is selected from lithium, sodium, potassium and ammonium;
x is 1 or 2; and
B is selected from Cl, CO₃²⁻, SO₄²⁻, carboxylate; silicate; borate; and mixtures thereof; to provide a first mixture [mixture (M1)];
(II) contacting said mixture (M1) with bis(chloro sulfonyl)imide (HCSI), so as to provide a second mixture [mixture (M2)] comprising a salt of HCSI [CSI salt] selected from lithium-, sodium-, potassium- or ammonium-CSI and at least one first solvent (S1);
(III) contacting said mixture (M2) with at least one second solvent [solvent (S2)], so as to provide the CSI salt in solid form, wherein said at least one second solvent (S2) forms a homogeneous mixture with said at least one first solvent (S1), and is an anti-solvent for said CSI salt.

2. The method according to claim 1, wherein in compound of formula (1):
M is lithium, said compound of formula (1) is selected from the group comprising LiCl, Li₂CO₃, Li₂SO₄, Liₙ(RCO₂)ₙ, Li₂SiO₃, Li₂B₄O₇ and mixture thereof; or
M is sodium and said compound of formula (1) is selected in the group comprising NaCl, Na₂CO₃, Na₂SO₄, and mixture thereof; or
M is ammonium and said compound of formula (1) is selected in the group comprising NH₄Cl, ammonium carbonate, and mixture thereof.

3. The method according to claim 1, wherein said solvent (S1) is selected in the group comprising: carbonates.

4. The method according to claim 1, wherein said solvent (S1) is different from thionyl chloride (SO₂Cl).

5. The method according to claim 1, wherein HCSI is provided in step (II) in its molten form.

6. The method according to claim 5, said method comprising before step (II), a step of heating HCSI at a temperature above its melting temperature (Tm_{HCSI}).

7. The method according to claim 1, wherein step (II) is performed at a temperature from 15 to 60 °C and/or at atmospheric pressure.

8. The method according to claim 1, wherein said at least one second solvent (S2) is selected in the group comprising: dioxane, chlorinated solvents, alkanes, toluene, and xylenes.

9. The method according to claim 1, wherein step (III) is performed at a temperature from 15 to 60 °C and/or at atmospheric pressure.

10. The method according to claim 1, wherein the CSI salt in solid form obtained at the end of step (III) is in the form of a solvate with said at least one second solvent (S2).

11. A solid solvate complex [CSI solvate] comprising a solid lithium, sodium, potassium or ammonium salt of bis(chloro sulfonyl)imide [CSI salt] and dioxane as the solvating solvent.

12. The CSI solvate according to claim 11, wherein the weight ratio of CSI salt to dioxane, in the CSI solvate, is in the range from 1:1 to 1:4, as measured on the dry powder.

13. A method of manufacturing a salt of bis(fluoro sulfonyl) imide [FSI salt], said method comprising:
(V) contacting the CSI salt as obtained according to claim 1, with at least one fluorinating agent, so as to obtain the FSI salt.

14. The method according to claim 13, wherein said fluorinating agent is selected from anhydrous hydrogen fluoride or in the group comprising:
(i) KF(HF)ₚ, wherein p is 0 or 1;
(ii) NaF(HF)ₚ, wherein p is 0 or 1;
(iii) X₂F(HF)ₚ, wherein X₂ is an onium cation, and p is 0 or 1;
(iv) NH₄F(HF)ₚ, wherein p varies between 0 and 10;
(v) LiF;
(vi) ZnF₂.

15. An electrolyte composition comprising the FSI salt as obtained at the end of the method according to claim 13.

16. A method of manufacturing a salt of bis(fluoro sulfonyl) imide [FSI salt], said method comprising:
(V) contacting the CSI solvate according to claim 11, with at least one fluorinating agent, so as to obtain the FSI salt.

17. The method according to claim 16, wherein said fluorinating agent is selected from anhydrous hydrogen fluoride or in the group comprising:
(i) KF(HF)ₚ, wherein p is 0 or 1;
(ii) NaF(HF)ₚ, wherein p is 0 or 1;
(iii) X₂F(HF)ₚ, wherein X₂ is an onium cation, and p is 0 or 1;
(iv) NH₄F(HF)ₚ, wherein p varies between 0 and 10;
(v) LiF;
(vi) ZnF₂.

18. An electrolyte composition comprising the FSI salt as obtained at the end of the method according to claim 16.
